(19) United States
(12) Patent Application Publication
(10) Pub. No.: US 2015/0022802 A1
(43) Pub. Date: Jan. 22, 2015

(54) SPECTROSCOPY DETECTION SYSTEM AND METHOD FOR MATERIAL IDENTIFICATION

(71) Applicants: Frederick Harold LONG, Randolph, NJ (US); Arun DESAI, East Brunswick, NJ (US)

(72) Inventors: Frederick Harold LONG, Randolph, NJ (US); Arun DESAI, East Brunswick, NJ (US)

(21) Appl. No.: 14/087,417

(22) Filed: Nov. 22, 2013

Related U.S. Application Data
(60) Provisional application No. 61/856,988, filed on Jul. 22, 2013.

(51) Int. Cl. G01N 21/55

(52) U.S. Cl. CPC G01N 21/55
USPC 356/51

(57) ABSTRACT

The present invention provides a method and system of chemical identification by using a short wavelength range of near infrared (NIR) such as in the range of near infrared (NIR) of about 600 to about 1100 nm. A silicon-detector can be used to measure the short wavelength of NIR region. A detection signal from a detector is sent to a computer. The computer is programmed with software modules for data acquisition of the detection signal and data analysis to determine absorption spectrum. The computer can include memory or remote access to one or more databases for storing a library of absorption spectra. The absorption spectrum of the material which provides the highest match value is identified as the material under inspection.

### BACKGROUND OF THE INVENTION

1. Field of the Invention

The present invention generally relates to applied spectroscopy, chemical identification and analysis. More specifically the present invention is an improved approach for material identification using a spectrometer and computer analysis.

2. Description of Related Art

Conventional methodologies are known for the identification of materials using spectroscopy. Raman spectroscopy was discovered by C. V. Raman in 1928. Numerous patents disclose the use of Raman instruments for material identification including U.S. Pat. Nos. 7,088,435 and 7,110,109. Raman works well in numerous cases but suffers from limitations. Some materials of interest exhibit phenomena known as fluorescence, which can overwhelm the measured Raman signal. Because modern renditions of Raman spectroscopy use a laser beam, there is a possible problem of sample heating or severe sample damage due to burning of the sample. This problem is a particular drawback when identifying highly explosive materials. Raman spectrometers have high monetary costs and are too expensive for some industries or for extensive use in the developing world.

Near infrared (NIR) spectroscopy originated with the pioneering work of Hershel in the nineteenth century. The near infrared (NIR) spectrum is typically defined to be the spectral region between 800-2500 nm. Absorption bands in the NIR region originate from the overtone and combination bands of high frequency chemical vibrations from CH, OH, and NH bonds. Because the absorption is due to overtone and combination bands that are only weakly allowed, the absorption in this region is much weaker than the well-known mid IR region (3000-10,000 nm). It has been recognized for some time that the traditional NIR region can be used to reliably identify materials.

U.S. Pat. No. 5,134,291 describes classifying plastic containers based on NIR spectroscopy. Numerous commercial products have been made using this entire spectral region.

U.S. Pat. No. 7,659,512 describes the discrimination of several different kinds of refined oil products by measuring the transmission of near infrared light through a liquid sample.

However, the photo detectors required for the longer NIR wavelengths are expensive. In particular, the commonly used InGaAs array detector is only made on a small commercial scale. Therefore NIR spectrometers have high manufacturing costs. Both Near IR and Raman are accepted technologies in the pharmaceutical industry.

The use of short wave length NIR region (600-1100 nm) has been described. This wavelength region has been used to quantify fat content in cow milk and determine alcohol content in beverages.

It is desirable to provide a method and system for qualitative prediction of an unknown material.

### SUMMARY OF THE INVENTION

There is widespread need for rapid, non-destructive material identification in numerous industries including, for example, pharmaceuticals, nutritional supplements, drug counterfeit detection, homeland security, chemical, polymers and plastics. The identification of incoming raw materials in the pharmaceutical and nutritional supplement industry is a critical task to ensure product safety and quality.

Pharmaceutical manufacturers are required to test incoming materials for chemical identity. There is increasing regulations being placed on the nutritional supplement industry. Furthermore the risks with product quality and possible adulteration are increasing with the import of raw materials from other parts of the world where quality standards may not be as high.

Numerous homeland security and military scenarios involve the identification of unknown materials. For example police officers need to rapidly determine if a white powder is an illicit-drug or a harmless white powder, such as sugar or baby powder. In a potentially hostile environment, military personal need to know if a powder is a dangerous explosive or a harmless material. This testing also needs to be done in such a way that there is little or no risk of igniting the material, which could be highly explosive.

The present invention provides a method and system of chemical identification by using a short wavelength range of near infrared (NIR) such as in the range of near infrared (NIR) about 600-about 1100 or 1150 nm. In contrast to the traditional range for NIR of 1100-2500 nm, a silicon-detector can be used to measure the short wavelength NIR region. Silicon array detectors, such as CCDs can be used in the present invention for detection of the short wavelength NIR region. A spectrometer using silicon array detectors for the short wavelength NIR region can be manufactured with low manufacturing costs compared to a counterpart spectrometers for the longer wavelength NIR region. Silicon array detectors do not require thermoelectric cooling which further reduces manufacturing costs and the power requirements of the device.

The invention will be more fully described by reference to the following drawings.

### BRIEF DESCRIPTION OF THE DRAWINGS

FIG. 1 is a schematic diagram of a spectroscopy detection system in accordance with the teachings of the present invention.

FIG. 2 is a flow diagram of a method for material identification in accordance with the teachings of the present invention.

FIG. 3 is a graph of an absorption spectrum.

FIG. 4 is a graph of a derivative spectrum.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

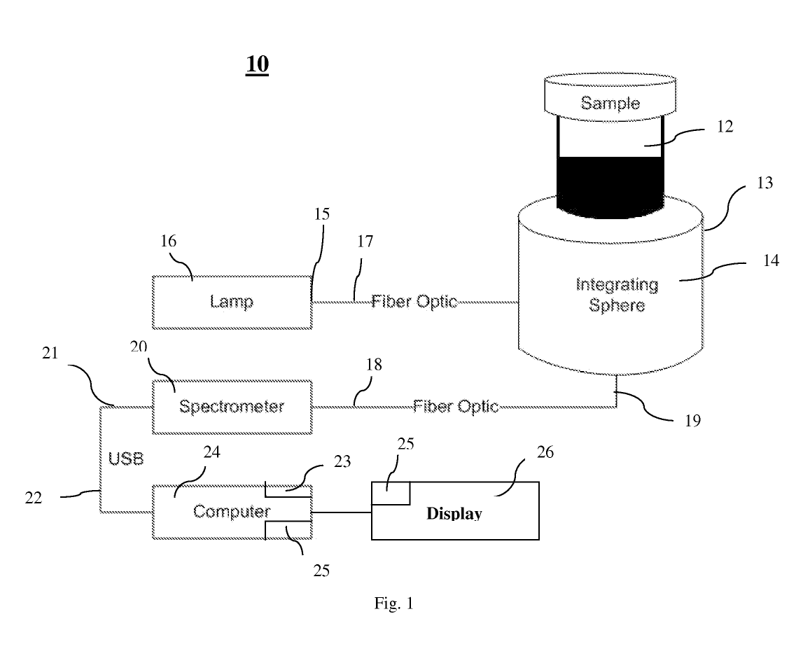

FIG. 1 is a schematic diagram of spectroscopy detection system 10 in accordance with the teachings of the present invention. Sample 12 is received in sample holder 13. For example, sample holder 13 can be a diffuse integrating sphere 14. A diffuse integrating sphere 14 efficiently collects light reflected off sample 12 and allows for investigation of many different forms of samples, such as for example powders, finished tablets, samples in plastic bags, and liquids. The efficient collection of the light is desirable because of the small absorbance signals in the short wavelength near infrared region (SWNIR).

Lamp 16 irradiates beam 15 through fiber optic probe 17 to sample holder 13. Lamp 16 generates beam 15 in the short wavelength of near infrared range of about 600 to about 1100 nm. Sample holder 13 reflects reflected beam 19 through fiber optic probe 18 to detector 20. In one embodiment, the lamp is part of the integrating sphere, eliminating the need for fiber optic cable 17.

In a preferred embodiment, detector 20 is a short wave length spectrometer. A suitable short wave length of near infrared spectrometer is an array silicon detector. An example spectrometer is AvaSpec 2048 or 128 USB powered spectrometer with a halogen lamp and an integrating sphere from Avantes Corporation.

Detection signal 21 from detector 20 is sent using universal serial bus (USB) connector 22 to computer 24. Computer 24 is programmed with software modules 23 for data acquisition of detection signal 21 and data analysis to determine absorption spectrum 25. Computer 24 can include memory or remote access to one or more databases for storing a library of absorption spectra. Absorption spectrum 25 can be displayed on display 26. Display 26 can be a touch-screen LCD to provide an interface to software modules 23.

Sample 12 can include chemical material, pharmaceutical material, and nutritional supplements. Sample 12 can include controlled substances such as for example illicit drugs and explosive materials. Sample 12 can include powdered materials. For example, sample 12 can include lyophilized powders, powdered baby formulas, powdered foods and powdered blends. Sample 12 can include pharmaceutical products such as tablets, soft gels, and pharmaceutical patches. Sample 12 can include plastics such as for example plastic packaging components.

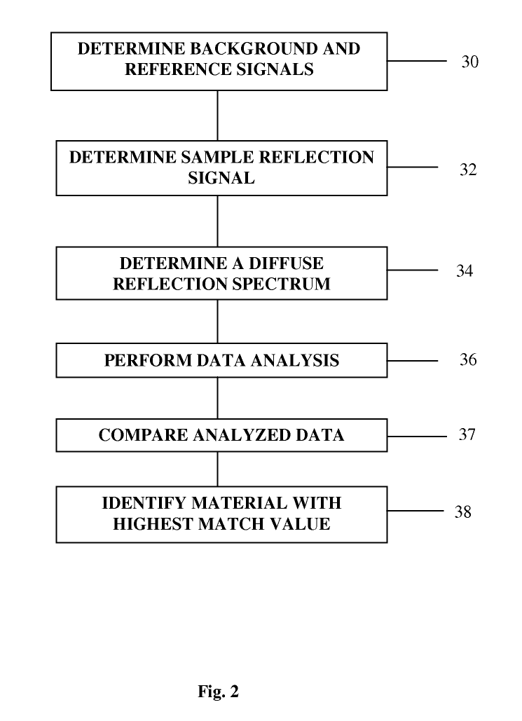

FIG. 2 is a flow diagram of a method for material identification in accordance with the teachings of the present invention. In block 30, background and reference signals are determined using system 10. The background measurement is determined from detection signal 21 when no light is incident on detector 20. The reference measurement is determined from detection signal 21 when a 99% reflection standard is used in sample holder 14.

In block 32, a sample reflection signal is determined from detection signal 21 when sample 12 is placed in sample holder 14. In block 34, a diffuse reflection spectrum is determined from the sample reflection signal S_{ref}, the background signal S_{background}, and reference signal S_{ref}. The reflection signal Rₘₐₜ is given by

$${R}_{mat} = \frac{{S}_{mat} - {S}_{background}}{{S}_{ref} - {S}_{background}}$$

The diffuse reflection signal Rₘₐₜ can be expressed in absorption units by the following equation.

A=−log₁₀Rₘₐₜ

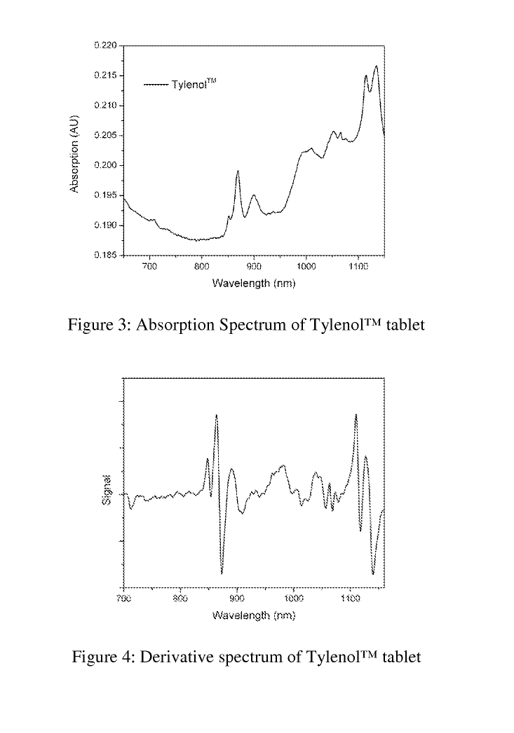

An example spectrum from a finished pharmaceutical product is shown in FIG. 3.

In block 36, data analysis is performed by software modules 23. In a preferred embodiment a numerical derivative of the measured spectrum is calculated. An example derivative spectrum is shown in FIG. 4 for a Tylenol® tablet.

In block 37, the normalized vector dot product of the derivative spectrum is compared with analogous spectra from a stored library of absorption spectra. In block 38, the material whose spectrum provides the highest normalized dot product or match value is then identified as the sample material under inspection. It will be appreciated that other mathematical methods can be used in accordance with the teachings of the present invention to identify or classify material spectra such as principal component analysis, soft independent modeling of class analogies (SIMCA), or partial least squares discriminant analysis (PLS-DA).

Embodiments of the present invention may be implemented in connection with a special purpose or general purpose telecommunications device that include both hardware and/or software components, including wireless telephones and other telephony-enabled wireless devices, landline telephones, or special purpose or general purpose computers that are adapted to have telecommunications capabilities.

Embodiments may also include physical computer-readable media and/or intangible computer-readable media for carrying or having computer-executable instructions, data structures, and/or data signals stored thereon. Such physical computer-readable media and/or intangible computer-readable media can be any available media that can be accessed by a general purpose or special purpose computer. By way of example, and not limitation, such physical computer-readable media can include RAM, ROM, EEPROM, CD-ROM or other optical disk storage, magnetic disk storage or other magnetic storage devices, other semiconductor storage media, or any other physical medium which can be used to store desired data in the form of computer-executable instructions, data structures and/or data signals, and which can be accessed by a general purpose or special purpose computer. Within a general purpose or special purpose computer, intangible computer-readable media can include electromagnetic means for conveying a data signal from one part of the computer to another, such as through circuitry residing in the computer.

When information is transferred or provided over a network or another communications connection (either hardwired, wireless, or a combination of hardwired or wireless) to a computer, hardwired devices for sending and receiving computer-executable instructions, data structures, and/or data signals (e.g., wires, cables, optical fibers, electronic circuitry, chemical, and the like) should properly be viewed as physical computer-readable mediums while wireless carriers or wireless mediums for sending and/or receiving computer-executable instructions, data structures, and/or data signals (e.g., radio communications, satellite communications, infrared communications, and the like) should properly be viewed as intangible computer-readable mediums. Combinations of the above should also be included within the scope of computer-readable media.

Computer-executable instructions include, for example, instructions, data, and/or data signals which cause a general purpose computer, special purpose computer, or special purpose processing device to perform a certain function or group of functions. Although not required, aspects of the invention have been described herein in the general context of computer-executable instructions, such as program modules, being executed by computers, in network environments and/or non-network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

Embodiments may also include computer program products for use in the systems of the present invention, the computer program product having a physical computer-readable medium having computer readable program code stored thereon, the computer readable program code comprising computer executable instructions that, when executed by a processor, cause the system to perform the methods of the present invention. The results of the computer analysis can be displayed on a LCD touch screen, cell phone, or printed out using a printer.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A detection system comprising:
a light source for illuminating at least a part of a sample with a beam having a short wavelength of near infrared range of near infrared about 600 to about 1100 nm;
a detector for detecting a reflected beam from said sample to generate a detection signal: and
means for data acquisition and data analysis of said detection signal to determine an identification of said sample.

2. The detection system of claim 1 further comprising a first optic probe for guiding said beam to said sample and a second probe for guiding said reflected beam to said detector.

3. The detection system of claim 1 further comprising a diffuse integrating sphere for holding said sample.

4. The detection system of claim 1 wherein said means for data acquisition and data analysis comprises determining a background signal S_{background},
determining a reference signal S_{ref}, and determining a reflection signal given
$${R}_{mat} = \frac{{S}_{mat} - {S}_{background}}{{S}_{ref} - {S}_{background}}$$
wherein the detection signal is Sₘₐₜ.

5. The detection system of claim 1 wherein the sample an chemical material, pharmaceutical material or nutritional supplement.

6. The detection system of claim 1 wherein the sample is a controlled substance.

7. The detection system of claim 1 wherein the sample is an illicit drug or explosive material.

8. The detection system of claim 1 wherein the sample is a powdered material selected from the group consisting of lyophilized powders, powdered baby formulas, powdered foods and powdered blends.

9. The detection system of claim 1 wherein the sample is a tablet or soft gel.

10. The detection system of claim 1 wherein the sample is a pharmaceutical patch.

11. The detection system of claim 1 wherein the sample is a plastic or plastic packaging component.

12. The detection system of claim 1 wherein the detector is an array silicon detector.

13. A method for material identification comprising the steps of:
illuminating at least a part of a sample of the material with a beam having a short wavelength range of about 600 to 1100 nm;
detecting a reflected beam from said sample to generate a detection signal: and
operating data acquisition and data analysis of said detection signal to determine an identification of said sample.

14. The method of claim 13 further comprising the steps of determining a background signal S_{background}
determining a reference signal S_{ref}, and determining a reflection signal Rₘₐₜ given by
$${R}_{mat} = \frac{{S}_{mat} - {S}_{background}}{{S}_{ref} - {S}_{background}}$$
wherein the detection signal is Sₘₐₜ.

15. The method of claim 13 further comprising a first optic probe for guiding said beam to said sample and a second probe for guiding said reflected beam to said detector.

16. The method of claim 13 further comprising a diffuse integrating sphere for holding said sample.

17. The method of claim 13 wherein said means for data acquisition and data analysis comprises determining a background signal S_{background},
determining a reference signal S_{ref}, and determining a reflection signal Rₘₐₜ given
$${R}_{mat} = \frac{{S}_{mat} - {S}_{background}}{{S}_{ref} - {S}_{background}}$$
wherein the detection signal is Sₘₐₜ.

18. The method of claim 13 wherein the sample an chemical material, pharmaceutical material or nutritional supplement.

19. The method of claim 13 wherein the sample is a controlled substance.

20. The method of claim 13 wherein the sample is an illicit drug or explosive material.

21. The method of claim 13 wherein the sample is a powdered material selected from the group consisting of lyophilized powders, powdered baby formulas, powdered foods and powdered blends.

22. The method of claim 13 wherein the sample is a tablet or soft gel.

23. The method of claim 13 wherein the sample is a pharmaceutical patch.

24. The method of claim 13 wherein the sample is a plastic or plastic packaging component.

25. The method of claim 13 wherein the detector is an array silicon detector.
